(19) United States
(12) Patent Application Publication
(10) Pub. No.: US 2026/0159310 A1
(43) Pub. Date: Jun. 11, 2026

(54) ROUND WASTE BIN LID FOR DOMESTIC WASTE BINS

(71) Applicant: Imam Abdulrahman Bin Faisal University, Dammam (SA)

(72) Inventors: Zainab ALHASHIM, Saihat (SA); Noran KATTAN, Dammam (SA); Akehlah ALSADIQ, Dammam (SA); Khadijah AL KHUWAITEM, Dammam (SA)

(73) Assignee: Imam Abdulrahman Bin Faisal University, Dammam (SA)

(21) Appl. No.: 18/974,539

(22) Filed: Dec. 9, 2024

(51) Int. Cl. B65F 1/16

(52) U.S. Cl. CPC B65F 1/1607; B65F 1/1646; B65F 2220/101; B65F 2250/114

(57) ABSTRACT

A circular waste bin cover for a waste bin and a method for assembling thereof are described. The circular waste bin cover includes a bottom support ring configured to attach to the waste bin, a top support ring, and a center expandable section therebetween and having pleats which are configured to open to permit the top support ring to move upward when an amount of waste within the waste bin exceeds a height of the waste bin. The waste bin cover also includes a plurality of weighted rotatable slides supported by axle rings connected to the top support ring. The weighted rotatable slides are configured to form a closed disposal door in an undeployed configuration and to rotate inward to receive the waste in a deployed configuration. The weighted rotatable slides are further configured to return to the undeployed configuration after the waste is received within the waste bin.

### STATEMENT OF ACKNOWLEDGEMENT

Financial support provided by the King Fahd University of Petroleum and Minerals (KFUPM), Riyadh, Saudi Arabia through Project No. EC221008 is gratefully acknowledged.

### BACKGROUND

### Technical Field

The present disclosure is directed to waste management systems and equipment, and more particularly to expandable waste bin covers for waste bins having self-closing disposal doors that facilitate safe and efficient waste disposal.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The proper management of waste is an important task for maintaining a clean and healthy environment. Domestic waste, generated from households and residential areas, constitutes a significant portion of the total waste stream. The collection and disposal of domestic waste are essential aspects of waste management systems. Domestic waste bins are commonly used for the temporary storage and collection of household waste. These waste bins are typically placed in designated areas for collection by waste management services. Waste collection in urban and residential areas typically involves manual handling of waste bins by collection workers. These waste bins are generally equipped with basic hinged or removable covers intended to contain waste and prevent spillage during storage periods.

However, conventional waste bins often present challenges in terms of capacity limitations, accessibility, and safety concerns. Standard waste bins typically have a fixed capacity, which can be insufficient during periods of high waste generation. This can lead to overfilling of bins, resulting in spillage, foul odors, and potential health hazards. Additionally, conventional waste bins may not be easily accessible for waste disposal, especially for elderly individuals or those with physical limitations. Furthermore, manual handling of waste bins presents safety risks as a substantial number of workers sustain injuries from sharp objects, overflowing waste, and hazardous materials during collection activities. These injuries often occur when workers need to interact directly with waste materials or when dealing with overfilled containers.

Conventional approaches to these challenges include basic safety equipment for workers, standard bin covers with simple hinged mechanisms, and fixed-capacity containers. Some waste bins utilize basic expansion mechanisms or overflow indicators to address capacity issues. However, these conventional solutions have significant limitations. Fixed-capacity bins often lead to overflow situations, forcing waste to be placed outside containers. Simple hinged covers do not prevent waste collector exposure to potentially hazardous materials during collection. Additionally, current designs typically lack mechanisms to accommodate varying waste volumes while maintaining safe operation, leading to increased risk of worker injury and environmental contamination.

U.S. Pat. No. 8,556,100B2 describes a collapsible container assembly including a foldable support member and flexible fingers around an opening. The collapsible container includes curved fingers that can overlap to form a continuous surface and automatically return to a closed position through memory characteristics when force is released. However, the collapsible container is a recyclable container meant to be disposed of and is not a permanent waste bin having a lid which is collapsible. Further, this reference does not describe a waste bin cover having weighted rotatable slides connected via axle rings to form a self-closing disposal door, nor does it describe a center expandable section with pleats configured to permit upward expansion.

US20190322418A1 describes an expandable and collapsible lid for use with a container, featuring collapsible rings that enable movement between non-deployed and deployed configurations. The lid can adapt to different container heights through its collapsible design. However, this reference does not describe a waste bin cover having weighted rotatable slides connected via axle rings to form a self-closing disposal door, nor does it describe a center expandable section with pleats configured to permit upward expansion.

WO2023200193A1 describes a waste bin comprising a telescopically expandable bin lid which can be extended downwardly in a telescopic manner, suitable for both circular and polygonal configurations. The lid is designed to compact trash through downward extension. However, this reference does not describe a waste bin cover having weighted rotatable slides connected via axle rings to form a self-closing disposal door, nor does it describe a center expandable section with pleats configured to permit upward expansion.

U.S. Pat. No. 5,244,109A describes an adjustable plastic lid for a garbage container that can expand to fit different sized containers through horizontal expansion. However, this reference does not describe a waste bin cover having weighted rotatable slides connected via axle rings to form a self-closing disposal door, nor does it describe a center expandable section with pleats configured to permit upward expansion.

Each of the aforementioned references suffers from one or more drawbacks hindering their adoption, such as lack of expandable capacity to accommodate varying waste volumes and automatic closure mechanisms to prevent waste exposure, limited adaptability to various bin sizes, and absence of features that promote user safety and convenience during waste disposal. Accordingly, it is one object of the present disclosure to provide a waste bin cover that addresses these limitations by incorporating an expandable section for increased capacity, at least one handle for secure grip, and a sealable door configured to open and close to receive waste. The waste bin cover of the present disclosure is designed to be adaptable to various bin sizes, enhancing both safety and user-friendliness in the handling of domestic waste.

### SUMMARY

In an exemplary embodiment, a circular waste bin cover for a waste bin is described, comprising: a bottom support ring configured to attach to the waste bin; a top support ring; a center expandable section configured to attach to an outer edge of the bottom support ring and to an outer edge of the top support ring, wherein the center expandable section includes pleats which are configured to open to permit the top support ring to move upward when an amount of waste within the waste bin exceeds a height of the waste bin; a plurality of axle rings connected to the top support ring, where each axle ring is configured to extend at least partially around an inner surface of an opening of the top support ring; and a plurality of weighted rotatable slides connected to the axle rings, wherein the plurality of weighted rotatable slides are configured to form a closed disposal door in an undeployed configuration and to rotate inward to receive the waste in a deployed configuration, wherein the plurality of weighted rotatable slides are configured to return to the undeployed configuration after the waste is received within the waste bin.

In another exemplary embodiment, a method for assembling an expandable circular waste bin cover for a cylindrical waste bin is described, comprising: connecting an outer edge of a bottom support ring to an outer edge of a top support ring by a pleated center expandable section comprising a synthetic leather; connecting a plurality of telescopic supports at a first end to a top surface of the bottom support ring and at a second end to a bottom surface of the top support ring; connecting a plurality of axle rings to an inner surface of the top support ring; connecting a plurality of weighted rotatable slides to the axle rings by inserting an end of each axle ring to a channel in a respective weighted rotatable slide, wherein the plurality of weighted rotatable slides are configured to form a closed disposal door in an undeployed configuration and to rotate inward to receive an amount of waste in a deployed configuration, wherein the plurality of weighted rotatable slides are configured to return to the undeployed configuration after the amount of waste is received within the waste bin; and moving the top support ring upward by expanding the pleats of the pleated center expandable section by an upward pressure formed by the amount of waste in the waste bin when the amount of waste exceeds a height of the waste bin.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary perspective diagram of a circular waste bin cover, according to certain embodiments.

FIG. 1B is an exemplary top planar diagram of the circular waste bin cover, according to certain embodiments.

FIG. 1C is an exemplary side planar diagram of the circular waste bin cover, according to certain embodiments.

FIG. 1D is an exemplary exploded diagram of the circular waste bin cover, according to certain embodiments.

FIG. 2 is an exemplary side planar diagram of a weighted rotatable slide of the circular waste bin cover, according to certain embodiments.

FIG. 3 is an exemplary depiction of assembly of the weighted rotatable slide with an axle ring connected to a top support ring of the circular waste bin cover, according to certain embodiments.

FIG. 4A is an exemplary depiction of the circular waste bin cover utilized with a cylindrical waste bin and disposed in an undeployed and unexpanded configuration, according to certain embodiments.

FIG. 4B is an exemplary depiction of the circular waste bin cover utilized with the cylindrical waste bin and disposed in a deployed and expanded configuration, according to certain embodiments.

FIG. 5 is an exemplary flowchart of listing steps involved in a method for assembling an expandable circular waste bin cover for a cylindrical waste bin, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a circular waste bin cover and a method for assembling the circular waste bin cover for a cylindrical waste bin. The waste bin cover of the present disclosure incorporates features that work in conjunction to prevent waste overflow, minimize direct contact with waste materials during collection, and ensure reliable operation in various environmental conditions. Unlike conventional waste bin covers, which often have fixed capacities and lack user-friendly features, the present waste bin cover is expandable and can self-adjust to accommodate varying waste volumes. This adaptability ensures that the waste bin cover can effectively manage waste during peak generation periods, preventing overfilling and spillage, as the waste bin cover design adapts to varying waste volumes while maintaining operational safety, resulting in efficient waste collection and management process.

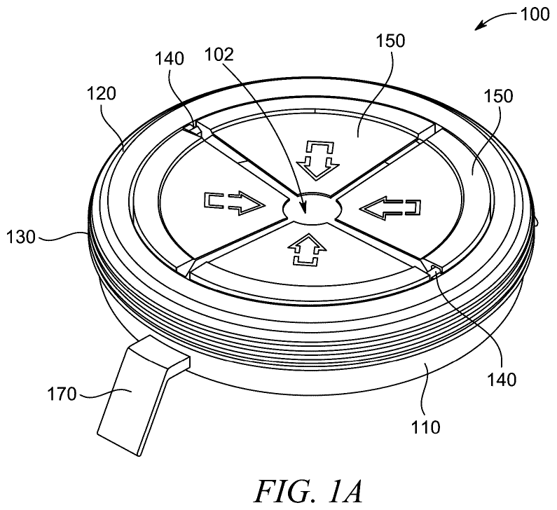

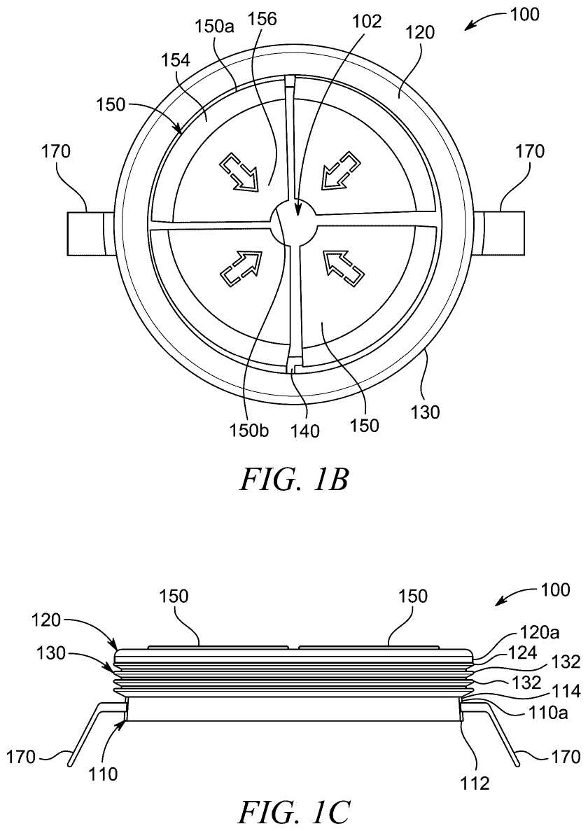

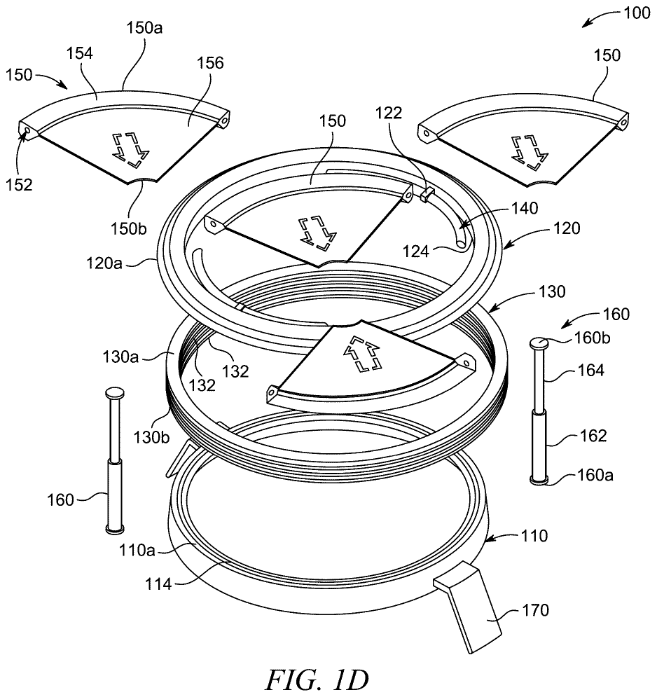

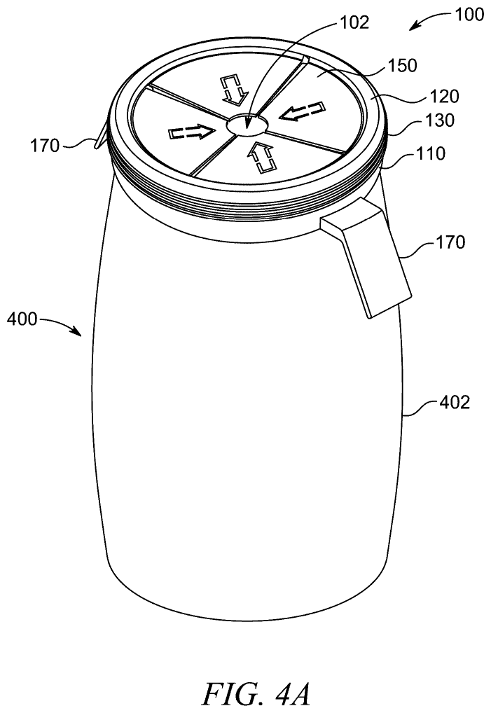

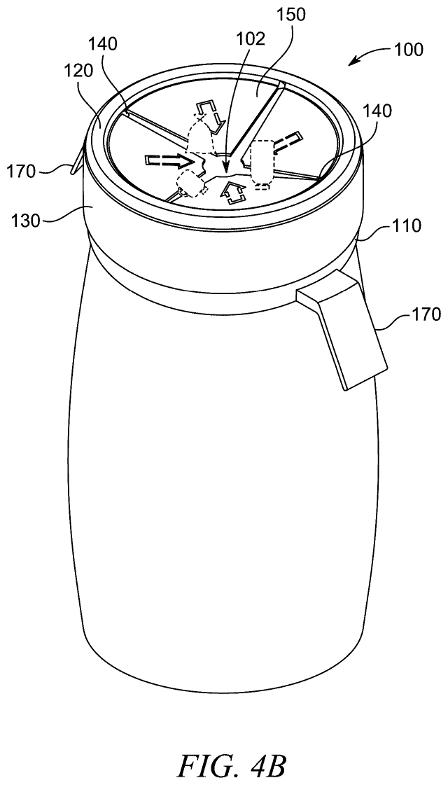

Referring to FIGS. 1A-1D in combination, illustrated are different views of a waste bin cover (as represented by reference numeral 100). In aspects of the present disclosure, the waste bin cover 100 has a circular configuration, and has been interchangeably referred to as “circular waste bin cover 100” without any limitations. The waste bin cover 100 of the present disclosure has a multi-component design configured to provide expandable capacity for waste disposal to a waste bin (as represented by reference numeral 400 in FIG. 4). The waste bin cover 100 is designed to be easily attachable to and removable from the waste bin 400, facilitating cleaning and maintenance operations. The waste bin cover 100 is further designed to be retrofitted onto existing cylindrical waste bins while maintaining a compact profile during normal operation. The waste bin cover 100 is adaptable to different operational scenarios while maintaining consistent performance in outdoor environmental conditions. The waste bin cover 100 is particularly suited for residential and commercial waste management applications where varying waste volumes and collection safety are primary concerns.

As illustrated in FIGS. 1A-1D, the circular waste bin cover 100 includes a bottom support ring 110, a top support ring 120, a center expandable section 130, a plurality of axle rings 140 and a plurality of weighted rotatable slides 150. In the circular waste bin cover 100, the bottom support ring 110 and the top support ring 120 are arranged in a parallel configuration, with the center expandable section 130 connecting the bottom support ring 110 and the top support ring 120. The plurality of axle rings 140 are connected to the top support ring 120, and the plurality of weighted rotatable slides 150 are mounted on the plurality of axle rings 140 in a radial arrangement, collectively forming a circular opening 102 in the circular waste bin cover 100. The components are generally assembled in a concentric arrangement, with the center expandable section 130 maintaining separation between the bottom support ring 110 and the top support ring 120, while simultaneously allowing for vertical expansion for the circular waste bin cover 100.

Particularly, in the circular waste bin cover 100, the bottom support ring 110 is configured to attach to the waste bin 400. For present purposes, the bottom support ring 110 has a circular configuration forming an inner opening. Specifically, the bottom support ring 110 is a circular ring-shaped component that serves as the base of the circular waste bin cover 100. The bottom support ring 110 is configured to rest on an upper rim of the waste bin 400, providing a stable platform for the waste bin cover 100. The bottom support ring 110 is made of a rigid material, such as plastic or metal, to ensure structural integrity and durability. In an example, the bottom support ring 110 may be manufactured from polypropylene (PP) plastic through injection molding processes. The use of polypropylene (PP) plastic provides structural rigidity and environmental durability. In an exemplary configuration, the bottom support ring 110 has an outer diameter that is slightly larger than the inner diameter of the waste bin 400, allowing it to securely rest on the rim of the waste bin 400. In an example, the bottom support ring 110 has an outer diameter of about 528.90 millimeters and an inner diameter (of the inner opening) of about 461.10 millimeters.

In present configuration, the bottom support ring 110 includes a downward-facing attachment channel 112 (generally represented in FIG. 1C) formed around a bottom edge thereof. The attachment channel 112 is configured to engage with the upper rim of the waste bin 400, providing secure fitment during waste disposal and collection operations. In an example, such attachment channel may have a width of about 21.75 millimeters and a depth of about 17.58 millimeters. The bottom support ring 110 has a second slot 114 (as shown in FIG. 1D) formed around an outer edge 110a thereof, for receiving and securing the center expandable section 130 (as discussed below in more detail). The bottom support ring 110 further includes support attachment points (not shown) distributed around the inner circumference of the bottom support ring 110 for connecting support members for the center expandable section 130 (again, discussed below in more detail).

The top support ring 120 is configured to form the upper portion of the circular waste bin cover 100. For present purposes, the top support ring 120 has a similar circular configuration to the bottom support ring 110, forming an inner opening. Specifically, the top support ring 120 is a circular ring-shaped component that serves as the upper platform of the circular waste bin cover 100. The top support ring 120 is configured to maintain parallel alignment with the bottom support ring 110. The top support ring 120 is made of a rigid material, such as plastic or metal, to ensure structural integrity and durability. In an example, the top support ring 120 may also be manufactured from PP plastic through the injection molding processes. In an exemplary configuration, the top support ring 120 has an outer diameter that is slightly smaller than the outer diameter of the bottom support ring 110, allowing the center expandable section 130 to maintain proper tensioning between the two rings. Further, the top support ring 120 has an inner diameter configured to accommodate the plurality of axle rings 140 and the plurality of weighted rotatable slides 150. In an example, the top support ring 120 has an outer diameter of about 551.22 millimeters and an inner diameter (of the inner opening) of about 230.55 millimeters.

In present configuration, as better illustrated in FIG. 1D, the top support ring 120 includes a plurality of axle ring mounting members 122 formed around an inner circumference thereof. Herein, each axle ring mounting member 122 is in the form of a protruding element extending inward from the inner circumference of the top support ring 120. In an example, the protruding element extends inward for about 15 millimeters. The axle ring mounting members 122 are configured to securely hold the plurality of axle rings 140 that support the weighted rotatable slides 150. The top support ring 120 also has a first slot 124 formed around an outer edge 120a thereof (generally represented in FIG. 1C), for receiving and securing the center expandable section 130 (as discussed later in more detail). The top support ring 120 further includes support connection points (not shown) positioned to align with the support attachment points of the bottom support ring 110, facilitating proper installation of the said support members for the center expandable section 130.

Further, for present purposes, the center expandable section 130 has a cylindrical configuration. The center expandable section 130 is a flexible cylindrical component that provides vertical expandability to the circular waste bin cover 100. In aspects of the present disclosure, the center expandable section 130 is made of synthetic leather. The center expandable section 130 is manufactured using synthetic leather material to provide the required combination of flexibility, durability, and environmental resistance for the circular waste bin cover 100. The synthetic leather material is selected based on specific physical properties including tear resistance, weather resistance, and pleating capability. In one aspect, the synthetic leather is made of polyvinyl chloride (PVC). The PVC-based synthetic leather is manufactured through a controlled layering process to achieve a thickness of about 1.2 millimeters, providing optimal balance between flexibility for pleating and structural integrity. The PVC-based synthetic leather may also incorporate reinforcement fiber backing to enhance durability and maintain dimensional stability during repeated expansion and contraction cycles of the center expandable section 130. In another aspect, the synthetic leather material is made of polyurethane (PU). The PU-based synthetic leather is processed to achieve similar physical characteristics, maintaining the required thickness of about 1.2 millimeters. The PU-based synthetic leather provides enhanced resistance to environmental factors while maintaining necessary flexibility for the operations of the center expandable section 130.

The center expandable section 130 includes pleats 132 which are configured to open to permit the top support ring 120 to move upward when an amount of waste within the waste bin 400 exceeds a height of the waste bin 400. Herein, the pleats 132 are in the form of a series of horizontal pleats 132 formed in the synthetic leather material, which extend continuously around the circumference of the center expandable section 130. Each pleat 132 is in the form of a fold in in the synthetic leather material having a depth of about 5 millimeters in a collapsed state, with adjacent pleats 132 being spaced at uniform intervals of about 10 millimeters. When an amount of waste within the waste bin 400 exceeds the height of the waste bin 400, the upward pressure from the excess waste causes the pleats 132 to unfold progressively, permitting the top support ring 120 to move upward relative to the bottom support ring 110. The pleats 132 are configured to provide vertical expansion of up to 30 centimeters beyond the initial collapsed height of the center expandable section 130. The synthetic leather material maintains sufficient rigidity in the pleats 132 to ensure automatic refolding of the pleats 132 when the upward pressure is removed, returning the center expandable section 130 to the collapsed configuration after the waste bin 400 is emptied.

In the circular waste bin cover 100, the center expandable section 130 is configured to attach to the outer edge 110a of the bottom support ring 110 and to the outer edge 120a of the top support ring 120. Specifically, the first slot 124 of the top support ring 120 and the second slot 114 of the bottom support ring 110 are configured to provide secure attachment for the center expandable section 130. Herein, the first slot 124 around the outer edge 120a of the top support ring 120 is configured for receiving a top edge 130a of the synthetic leather of the center expandable section 130, and the second slot 114 around the outer edge 110a of the bottom support ring 110 is configured for receiving a bottom edge 130b of the synthetic leather of the center expandable section 130. The first slot 124 extends continuously around the outer edge 120a of the top support ring 120, having a depth of about 5 millimeters and a width of about 2 millimeters to accommodate the thickness of the synthetic leather material of the center expandable section 130. Similarly, the second slot 114 extends continuously around the outer edge 110a of the bottom support ring 110, with generally same dimensions as the first slot 124 for installation of the center expandable section 130. In present configuration, the top edge 130a of the synthetic leather is glued to the first slot 124, and the bottom edge 130b of the synthetic leather is glued to the second slot 114. The adhesive may be an industrial-grade adhesive applied along the entire length of the first slot 124 and the second slot 114 prior to insertion of the top edge 130a and the bottom edge 130b, respectively, of the synthetic leather material therein, ensuring uniform bonding around the complete circumference of the top support ring 120 and the bottom support ring 110 corresponding thereto.

Also, as illustrated, the plurality of axle rings 140 are connected to the top support ring 120. Herein, each axle ring 140 is configured to extend at least partially around an inner surface of an opening of the top support ring 120. Specifically, each axle ring 140 includes a curved member having an arc length configured to extend partially around the inner circumference of the top support ring 120. In present configuration, each axle ring 140 is configured to mount within corresponding axle ring mounting members 122 of the top support ring 120. Each axle ring 140 extends bilaterally from corresponding protruding axle ring mounting member 122 to form circular end portions on opposing sides. The axle rings 140 are positioned symmetrically around the inner circumference of the top support ring 120, with each axle ring 140 being separated from adjacent axle rings 140. For present purposes, the axle rings 140 may be manufactured from polypropylene (PP) plastic through injection molding processes to provide structural rigidity and durability required for rotational movement. In an exemplary configuration, each axle ring 140 has a diameter of about 6 millimeters and extends for an arc length of about 45 degrees around the inner circumference of the top support ring 120.

Further, the plurality of weighted rotatable slides 150 are connected to the axle rings 140. The plurality of weighted rotatable slides 150 are connected to the axle rings 140, forming a door for the circular waste bin cover 100. Herein, the weighted rotatable slides 150 are configured to form a closed disposal door in an undeployed configuration and to rotate inward to receive the waste in a deployed configuration. The weighted rotatable slides 150 are arranged in a radial pattern around the opening in the circular waste bin cover 100, forming the door for the said opening when in the undeployed configuration. Specifically, in the undeployed configuration, the weighted rotatable slides 150 close together to prevent waste from spilling out; while in the deployed configuration, the weighted rotatable slides 150 open to receive waste into the waste bin 400. Further, the plurality of weighted rotatable slides 150 are configured to return to the undeployed configuration after the waste is received within the waste bin 400. The weighted design of the slides 150 ensures that they return to the undeployed, closed configuration after waste is received.

Each weighted rotatable slide 150 has a wedge configuration in which a first end 150a has a shape of a circular sector which tapers to a second end 150b. Herein, the first end 150a has a shape of the circular sector with an arc length corresponding to the circumferential spacing between adjacent axle rings 140. In an example configuration, the arc length is about 45 degrees. The circular sector at the first end 150a has a radius substantially matching the inner radius of the top support ring 120. From the first end 150a, each weighted rotatable slide 150 tapers uniformly to the second end 150b, forming the wedge-shaped profile. This wedge-shaped profile provides that the plurality of weighted rotatable slides 150 together form the door for the opening in the circular waste bin 400.

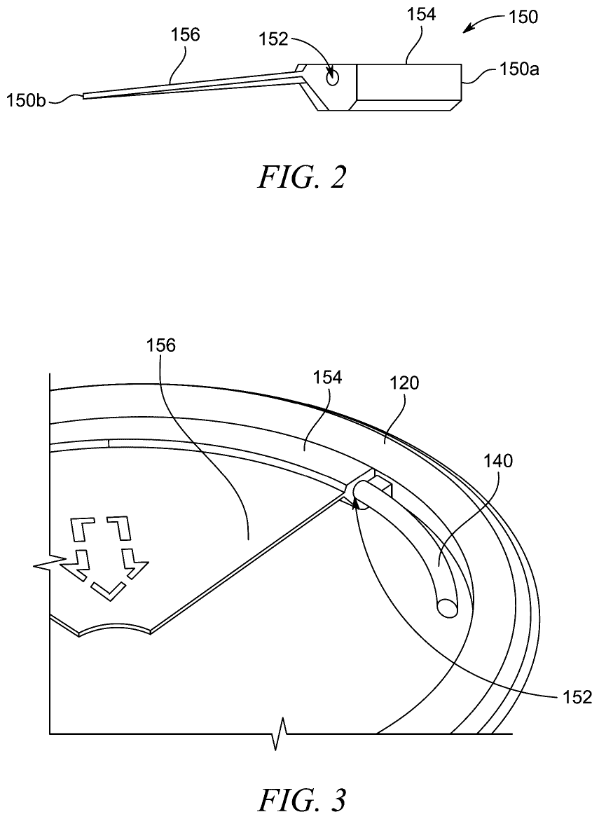

In an aspect, each weighted rotatable slide 150 includes a channel 152 located in the circular sector. The channel 152 is configured to receive an end of one of the plurality of axle rings 140. This configuration enables rotational movement of the weighted rotatable slide 150 about the corresponding axle ring 140. For present purposes, as better illustrated in FIG. 2, the channel 152 includes an opening extending through the thickness of the first end 150a of the weighted rotatable slide 150. Herein, a center of the channel 152 is positioned at a predetermined distance from an outer edge of the circular sector. In an exemplary configuration, the channel 152 is positioned at about one-third of the radius of the circular sector from the outer edge, providing leverage for the rotational movement of the weighted rotatable slide 150. Further, as illustrated in FIG. 3, the channel 152 is dimensioned to accommodate secure engagement with the corresponding axle ring 140 while permitting free rotational movement of the weighted rotatable slide 150 about the axle ring 140. In an example, the channel 152 has an inner diameter slightly larger than the outer diameter of the axle rings 140 to facilitate smooth rotational movement while preventing lateral displacement of the weighted rotatable slide 150.

Furthermore, the second end 150b of each weighted rotatable slide 150 is shaped as a convex arc. The convex arc configuration of the second end 150b enables adjacent weighted rotatable slides 150 to form a continuous surface in the undeployed configuration. The second ends 150b of the plurality of weighted rotatable slides 150 form the circular opening 102 in the closed disposal door in the undeployed configuration. Herein, a diameter of the circular opening is about one sixth of a diameter of the top support ring 120. In an exemplary configuration, with the top support ring 120 having an inner diameter of about 461.10 millimeters, the circular opening formed by the second ends 150b of the weighted rotatable slides 150 has a diameter of about 38.45 millimeters. For present purposes, the convex arc of each second end 150b is configured with a radius of curvature that allows the plurality of weighted rotatable slides 150 to form a continuous transition between adjacent slides while defining the circular opening in the undeployed configuration.

In an aspect of the present disclosure, each weighted rotatable slide 150 includes a weighted region 154 between the channel 152 and the first end 150a. The weighted region 154 is configured to provide counterbalancing weight distribution for the weighted rotatable slide 150. A weight of the weighted region 154 is equal to or greater than a weight of a section 156 of the weighted rotatable slide 150 between the channel 152 and the second end 150b. In present configuration, the weighted region 154 incorporates a thickened portion of the first end 150a of the weighted rotatable slide 150. The thickness of the weighted region 154 is configured to achieve weight equilibrium with the section 156. For present purposes, the section 156 includes the remaining portion of the weighted rotatable slide 150 extending from the channel 152 to the second end 150b. Herein, the weight distribution enables automatic return of the weighted rotatable slide 150 to the undeployed configuration after waste disposal. Specifically, the equal weight distribution about the channel 152 maintains the weighted rotatable slide 150 in the undeployed configuration when not acted upon by external forces.

The section 156 of each weighted rotatable slide 150 between the channel 152 and the second end 150b is wedge shaped. Specifically, the wedge shaped section 156 tapers uniformly from the channel 152 to the second end 150b of the weighted rotatable slide 150. Further, the wedge shaped section 156 is tilted at an angle in a range of two degrees to ten degrees with respect to the weighted region 154 between the channel 152 and the first end 150a. For present purposes, this angular configuration of the wedge shaped section 156 facilitates controlled inward rotation of the weighted rotatable slide 150 during waste disposal operations. In an exemplary configuration, the wedge shaped section 156 is tilted at an angle of about five degrees with respect to the weighted region 154, providing balance between ease of rotation during waste disposal and providing return to the undeployed configuration. The tilted configuration of the wedge shaped section 156, in combination with the equal weight distribution about the channel 152, facilitates the weighted rotatable slide 150 to maintain stability in the undeployed configuration while permitting inward rotation under application of forces from weight of waste disposal.

In a first aspect of the present disclosure, the plurality of axle rings 140 consists of a first axle ring and a second axle ring located on opposite sides of the top support ring 120. Herein, each axle ring 140 is configured to hold two weighted rotatable slides 150. Specifically, in this configuration, the first axle ring and the second axle ring are positioned at diametrically opposite points along the inner circumference of the top support ring 120. The weighted rotatable slides 150 are arranged such that two weighted rotatable slides 150 are mounted on each of two axle rings, resulting in a total of four weighted rotatable slides 150 forming the circular opening 102. This configuration provides 180-degree spacing between the first axle ring and the second axle ring, enabling symmetric distribution of the weighted rotatable slides 150 around the circular opening 102 of the circular waste bin cover 100.

In a second aspect of the present disclosure, the plurality of axle rings 140 consists of a first axle ring, a second axle ring and a third axle ring evenly spaced around the top support ring 120. Herein, each axle ring 140 is configured to hold two weighted rotatable slides 150. In this arrangement, the first axle ring, the second axle ring, and the third axle ring are positioned at 120-degree intervals around the inner circumference of the top support ring 120. Each of the three axle rings supports two weighted rotatable slides 150, providing a total of six weighted rotatable slides 150 forming the circular opening 102. Such distribution of axle rings ensures uniform spacing and balanced operation of the weighted rotatable slides 150 around the circular opening 102 of the circular waste bin cover 100.

In a third aspect of the present disclosure, there are N weighted rotatable slides 150, and the top support ring 120 has an inner circumference C and a width of the circular sector of each of the plurality of weighted rotatable slides is about C/N. For present purposes, the inner circumference C of the top support ring 120 and the number N of weighted rotatable slides 150 determine the width of the circular sector of each weighted rotatable slide 150. As an example, with an inner circumference C of about 724.5 millimeters (based on the inner diameter of 230.55 millimeters) and N equal to six weighted rotatable slides 150, the width of the circular sector of each weighted rotatable slide 150 is approximately 120.75 millimeters. This dimensional relationship ensures proper coverage of the circular opening 102 while maintaining appropriate overlap between adjacent weighted rotatable slides 150 in the undeployed configuration.

Specifically referring to FIG. 1D, as illustrated, the circular waste bin cover 100 further includes a plurality of telescopic supports 160 configured to connect at a first end 160a to a top surface of the bottom support ring 110 and at a second end 160b to a bottom surface of the top support ring 120. Herein, the first end 160a of each telescopic support 160 is configured to engage with corresponding said support attachment points around the inner circumference of the bottom support ring 110. Similarly, the second end 160b of each telescopic support 160 is configured to engage with corresponding support connection points on the bottom surface of the top support ring 120. As the support connection points of the top support ring 120 are positioned in vertical alignment with the support attachment points of the bottom support ring 110, this provides for vertical disposal of the telescopic supports 160. In the circular waste bin cover 100, the plurality of telescopic supports 160 are positioned behind the center expandable section 130 in connection therewith, providing structural support while allowing for vertical expansion of the circular waste bin cover 100.

In an aspect of the present disclosure, each telescopic support 160 includes a first cylinder 162 having a first diameter and a second cylinder 164 having a second diameter which is less than the first diameter. For present purposes, the first cylinder 162 and the second cylinder 164 are manufactured from polypropylene (PP) plastic through injection molding processes to provide structural rigidity and durability. In an exemplary configuration, the first cylinder 162 has an inner diameter of about 12 millimeters, while the second cylinder 164 has an outer diameter of about 11 millimeters, providing suitable clearance for telescopic movement. The second cylinder 164 is configured to nest within the first cylinder 162 when an amount of waste is below a level of the bottom support ring 110 and to slide within the first cylinder 162 to permit the top support ring 120 to move upward when an amount of waste within the waste bin 400 exceeds a height of the waste bin 400. Specifically, in the nested configuration, the second cylinder 164 is substantially contained within the first cylinder 162, maintaining a compact profile of the circular waste bin cover 100. Upon expansion, the second cylinder 164 slides upward within the first cylinder 162, extending the telescopic support 160 while maintaining vertical alignment between the top support ring 120 and the bottom support ring 110, and thereby causing expansion of the center expandable section 130.

In present configuration, an end of the second cylinder 164 which fits within the first cylinder 162 is configured with an inner ring protrusion, and an internal surface of a first end of the first cylinder 162 includes a jagged profile configured to prevent the inner ring protrusion of the second cylinder 164 from moving past the first end of the first cylinder 162. Herein, the inner ring protrusion may be in the form of a continuous circular ridge formed around an inner surface of the second cylinder 164. In an example, the inner ring protrusion extends inward for about 1 millimeter. The jagged profile of the first cylinder 162 may include a series of angled ridges formed around the internal surface of the first end thereof. These angled ridges are configured to engage with the inner ring protrusion of the second cylinder 164. For present purposes, when the second cylinder 164 extends to a maximum height during expansion of the circular waste bin cover 100, the inner ring protrusion contacts the jagged profile, preventing separation of the second cylinder 164 from the first cylinder 162 while maintaining structural integrity of the telescopic support 160.

The waste bin cover 100 further includes at least one handle 170 connected to the top support ring 120. The at least one handle 170 is configured to provide a grip for lifting the circular waste bin cover 100, for attaching/removal from the circular waste bin 400. In the present examples, as illustrated, the waste bin cover 100 includes two handles 170 disposed diametrically opposite to each other on the top support ring 120. Herein, the at least one handle 170 may be connected to the top support ring 120 by a plurality of screws. The plurality of screws may pass through a plurality of holes in the at least one handle 170 and into a plurality of threaded holes in the top support ring 120. In an exemplary configuration, the at least one handle 170 is manufactured from polypropylene (PP) plastic through injection molding processes to provide structural rigidity and durability. The at least one handle 170 may be manufactured as a single component or as two components connected together without any limitations.

Referring now to FIGS. 4A and 4B, depicted are examples of the circular waste bin cover 100 utilized with the cylindrical waste bin 400. Specifically, FIG. 4A depicts the circular waste bin cover 100 disposed in the unexpanded configuration wherein the lid is undeployed and FIG. 4B depicts the circular waste bin cover 100 disposed in the expanded configuration where the lid is partially deployed. As illustrated, the waste bin 400 has a cylindrical configuration and the bottom support ring 110, the center expandable section 130, and the top support ring 120 are circular and sized to fit over a circular opening (not visible) of the waste bin 400. For present purposes, the circular configuration of the components corresponds to the upper rim of cylindrical shaped body 402 of the waste bin 400, ensuring proper fitment and operation of the circular waste bin cover 100. The center expandable section 130 connects these circular components while maintaining the circular profile, in which the diameter of the center expandable section 130 transitions from the larger diameter of the bottom support ring 110 to the smaller diameter of the top support ring 120, ensuring proper coverage of the circular opening 102 of the waste bin 400 throughout the range of expansion.

Referring to FIG. 4A, the center expandable section 130 is shown in a contracted state wherein the pleats 132 of the center expandable section 130 are compactly folded between the bottom support ring 110 and the top support ring 120. When an amount of waste within the waste bin 400 exceeds the height of the body 402 of the waste bin 400, the upward force from the excess waste causes the center expandable section 130 to transition to an expanded state as shown in FIG. 4B. In the expanded state, the pleats 132 of the center expandable section 130 unfold progressively, permitting the top support ring 120 to move upward relative to the bottom support ring 110, while the plurality of telescopic supports 170 extend correspondingly to maintain structural stability. The transition between the contracted state of FIG. 4A and the expanded state of FIG. 4B demonstrates the vertical expansion capability provided by the center expandable section 130. The center expandable section 130 is further configured to automatically return to the contracted state (as shown in FIG. 4A) when the upward force is removed upon emptying of the waste bin 400.

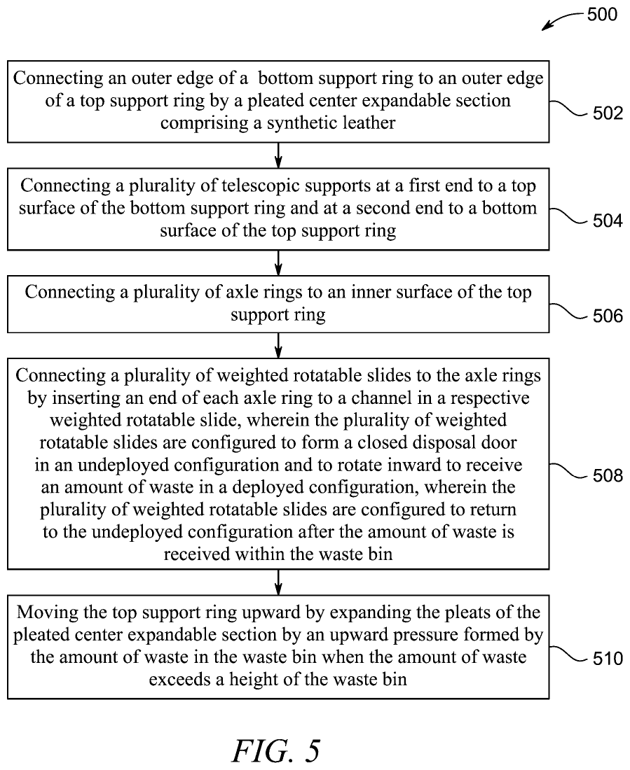

Referring now to FIG. 5, the present disclosure further provides a method (as represented by a flowchart, referred by reference numeral 500) for assembling an expandable circular waste bin cover (same as the circular waste bin cover 100, with the two terms being interchangeably used hereinafter) for the cylindrical waste bin 100. The method 500 includes a series of steps. These steps are only illustrative, and other alternatives may be considered where one or more steps are added, one or more steps are removed, or one or more steps are provided in a different sequence without departing from the scope of the present disclosure. Various variants disclosed above, with respect to the aforementioned circular waste bin cover 100 apply mutatis mutandis to the present method 500 for assembly thereof.

At step 502, the method 500 includes connecting the outer edge 110a of the bottom support ring 110 to the outer edge 120a of the top support ring 120 by a pleated center expandable section 130 comprising the synthetic leather. The bottom support ring 110 and the top support ring 120 are arranged in a parallel configuration. The pleated center expandable section 130 is attached to the outer edges 110a, 120a of the bottom support ring 110 and the top support ring 120, respectively, by inserting the top edge 130a and the bottom edge 130b of the pleated center expandable section 130 into the corresponding first slot 124 and the second slot 114 formed in the top support ring 120 and the bottom support ring 110, respectively. Subsequently, the top edge 130a and the bottom edge 130b of the pleated center expandable section 130 are glued to the first slot 124 and the second slot 114, respectively, using the adhesive.

At step 504, the method 500 includes connecting the plurality of telescopic supports 160 at the first end 160a to the top surface of the bottom support ring 110 and at the second end 160b to the bottom surface of the top support ring 120. The plurality of telescopic supports 160 are distributed circumferentially around the bottom support ring 110 and the top support ring 120. Each telescopic support 160 is attached to the top surface of the bottom support ring 110 and the bottom surface of the top support ring 120 using screws or rivets. The telescopic supports 160 are arranged in a manner that maintains the bottom support ring 110 and the top support ring 120 in a parallel configuration while allowing for vertical expansion of the pleated center expandable section 130.

At step 506, the method 500 includes connecting the plurality of axle rings 140 to the inner surface of the top support ring 120. The plurality of axle rings 140 are distributed circumferentially around the inner surface of the top support ring 120. Each axle ring 140 is connected to the inner surface of the top support ring 120 by inserting an end of the axle ring 140 into a corresponding axle ring mounting member 122 formed in the top support ring 120. The axle rings 140 are arranged in a manner that allows for the attachment of the plurality of weighted rotatable slides 150, which collectively form the closed disposal door in the undeployed configuration.

At step 508, the method 500 includes connecting the plurality of weighted rotatable slides 150 to the axle rings 140 by inserting an end of each axle ring 140 to a channel in the respective weighted rotatable slide 150. Herein, the plurality of weighted rotatable slides 150 are configured to form the closed disposal door in the undeployed configuration and to rotate inward to receive an amount of waste in the deployed configuration. Further, the plurality of weighted rotatable slides 150 are configured to return to the undeployed configuration after the amount of waste is received within the waste bin 400. The plurality of weighted rotatable slides 150 are distributed circumferentially around the inner surface of the top support ring 120. Each weighted rotatable slide 150 is connected to the corresponding axle ring 140 by inserting an end of the axle ring 140 into the channel in the respective weighted rotatable slide 150. The weighted rotatable slides 150 are arranged in a manner that allows them to form the closed disposal door in the undeployed configuration and to rotate inward to receive an amount of waste in the deployed configuration. The weighted design of the weighted rotatable slides 150 ensures that they return to the undeployed configuration after the amount of waste is received within the waste bin 400.

At step 510, the method 500 includes moving the top support ring 120 upward by expanding the pleats 132 of the pleated center expandable section 130 by an upward pressure formed by the amount of waste in the waste bin 400 when the amount of waste exceeds a height of the waste bin 400. When the amount of waste in the waste bin 400 exceeds the height of the waste bin 400, the excess waste exerts an upward pressure on the top support ring 120. This upward pressure causes the pleats 132 of the pleated center expandable section 130 to expand, allowing the top support ring 120 to move upward. The upward movement of the top support ring 120 increases the overall capacity of the waste bin 400, accommodating the excess waste without spillage.

In an aspect, the method 500 further includes forming the plurality of weighted rotatable slides 150 into the wedge configuration in which the first end 150a has a shape of a circular sector which tapers to the second end 150b. This wedge configuration is achieved by molding or shaping the weighted rotatable slides 150 during the manufacturing process. The first end 150a of each weighted rotatable slide 150, having the shape of the circular sector, is positioned towards the inner circumference of the top support ring 120, while the second end 150b, which is tapered, is positioned towards the center of the circular opening 102. This arrangement ensures that the weighted rotatable slides 150 can effectively open and close the disposal door, providing a secure seal when in the undeployed configuration. The method 500 further includes weighting each circular sector of each of the plurality of weighted rotatable slides 150 in the weighted region 154 between the channel and the first end 150a. Herein, the weight of the weighted region 154 is equal to a weight of the section 156 of the slide 150 between the channel and the second end 150b. This balanced weighting ensures that the weighted rotatable slides 150 can rotate freely on the axle rings 140, allowing them to open and close the disposal door without any hindrance. The weighting also ensures that the weighted slides 150 return to the undeployed, closed configuration after waste is received, effectively sealing the disposal door and preventing any spillage or odor.

The circular waste bin cover 100 and the method 500 of the present disclosure provide a significant advancement in waste management technology, providing a unique combination of features that address the limitations of conventional waste bin covers. The expandable capability of the circular waste bin cover 100 allows it to adapt to varying waste volumes, preventing overfilling and spillage. Such expandable design of the circular waste bin cover 100 eliminates the need for larger waste bins, which can be cumbersome and difficult to maneuver. The integration of the disposal door, formed by the plurality of weighted rotatable slides 150, ensures controlled waste disposal and prevents unwanted access to contents inside the circular waste bin 400. The ease of attachment and removal of the circular waste bin cover 100 facilitates cleaning and maintenance operations, ensuring its longevity and hygiene. Further, the adaptability of the circular waste bin cover 100 to various bin sizes further enhances its versatility and practicality. This adaptability allows the circular waste bin cover 100 to be used in a variety of settings, including residential, commercial, and industrial environments.

A first embodiment describes a circular waste bin cover 100 for a waste bin 400, comprising: a bottom support ring 110 configured to attach to the waste bin 400; a top support ring 120; a center expandable section 130 configured to attach to an outer edge 110a of the bottom support ring 110 and to an outer edge 120a of the top support ring 120, wherein the center expandable section 130 includes pleats 132 which are configured to open to permit the top support ring 120 to move upward when an amount of waste within the waste bin 400 exceeds a height of the waste bin 400; a plurality of axle rings 140 connected to the top support ring 120, where each axle ring 140 is configured to extend at least partially around an inner surface of an opening of the top support ring 120; and a plurality of weighted rotatable slides 150 connected to the axle rings 140, wherein the plurality of weighted rotatable slides 150 are configured to form a closed disposal door in an undeployed configuration and to rotate inward to receive the waste in a deployed configuration, wherein the plurality of weighted rotatable slides 150 are configured to return to the undeployed configuration after the waste is received within the waste bin 400.

In an aspect, the waste bin 400 has a cylindrical configuration and the bottom support ring 110, the center expandable section 130, and the top support ring 120 are circular and sized to fit over a circular opening of the waste bin 400.

In an aspect, the plurality of weighted rotatable slides 150 each have a wedge configuration in which a first end 150a has a shape of a circular sector which tapers to a second end 150b.

In an aspect, the waste bin cover 100 further comprises: a channel located in the circular sector of each weighted rotatable slide 150, wherein the channel is configured to receive an end of one of the plurality of axle rings 140.

In an aspect, the plurality of axle rings 140 consists of a first axle ring and a second axle ring located on opposite sides of the top support ring 120, wherein each axle ring 140 is configured to hold two weighted rotatable slides 150.

In an aspect, the plurality of axle rings 140 consists of a first axle ring, a second axle ring and a third axle ring evenly spaced around the top support ring 120, wherein each axle ring 140 is configured to hold two weighted rotatable slides 150.

In an aspect, there are N weighted rotatable slides 150, the top support ring 120 has an inner circumference C and a width of the circular sector of each of the plurality of weighted rotatable slides 150 is about C/N.

In an aspect, the second end 150b of each weighted rotatable slide 150 is shaped as a convex arc and the second ends 150b of the plurality of weighted rotatable slides 150 form a circular opening 102 in the closed disposal door in the undeployed configuration, wherein a diameter of the circular opening 102 is about one sixth of a diameter of the top support ring 120.

In an aspect, each circular sector of the plurality of weighted rotatable slides 150 includes a weighted region 154 between the channel and the first end 150a, wherein a weight of the weighted region 154 is equal to a weight of a section 156 of the slide 150 between the channel and the second end 150b.

In an aspect, the section 156 of each weighted rotatable slide 150 between the channel and the second end 150b is wedge shaped, wherein the wedge shaped section 156 is tilted at an angle in a range of two degrees to ten degrees with respect to the weighted region 154 between the channel and the first end 150a.

In an aspect, the waste bin cover 100 further comprises: a plurality of telescopic supports 160 configured to connect at a first end 160a to a top surface of the bottom support ring 110 and at a second end 160b to a bottom surface of the top support ring 120.

In an aspect, each telescopic support 160 includes a first cylinder 162 having a first diameter and a second cylinder 164 having a second diameter which is less than the first diameter, wherein the second cylinder 164 is configured to nest within the first cylinder 162 when an amount of waste is below a level of the bottom support ring 110 and to slide within the first cylinder 162 to permit the top support ring 120 to move upward when an amount of waste within the waste bin 400 exceeds a height of the waste bin 400.

In an aspect, an end of the second cylinder 164 which fits within the first cylinder 162 is configured with an inner ring protrusion, and an internal surface of a first end of the first cylinder 162 includes a jagged profile configured to prevent the inner ring protrusion of the second cylinder 164 from moving past the first end of the first cylinder 162.

In an aspect, the center expandable section 130 is made of synthetic leather.

In an aspect, the synthetic leather is made of polyvinyl chloride.

In an aspect, the synthetic leather is made of polyurethane.

In an aspect, the waste bin cover 100 further comprises: a first slot 124 around an outer edge 120a of the top support ring 120 configured for receiving a top edge 130a of the synthetic leather of the center expandable section 130, wherein the top edge 130a of the synthetic leather is glued to the first slot 124; and a second slot 114 around an outer edge 110a of the bottom support ring 110 configured for receiving a bottom edge 130b of the synthetic leather of the center expandable section 130, wherein the bottom edge 130b of the synthetic leather is glued to the second slot 114.

In an aspect, the waste bin cover 100 further comprising at least one handle 170 connected to the top support ring 120.

A second embodiment describes a method 500 for assembling an expandable circular waste bin cover 100 for a cylindrical waste bin 400, comprising: connecting an outer edge 110a of a bottom support ring 110 to an outer edge 120a of a top support ring 120 by a pleated center expandable section 130 comprising a synthetic leather; connecting a plurality of telescopic supports 160 at a first end 160a to a top surface of the bottom support ring 110 and at a second end 160b to a bottom surface of the top support ring 120; connecting a plurality of axle rings 140 to an inner surface of the top support ring 120; connecting a plurality of weighted rotatable slides 150 to the axle rings 140 by inserting an end of each axle ring 140 to a channel in a respective weighted rotatable slide 150, wherein the plurality of weighted rotatable slides 150 are configured to form a closed disposal door in an undeployed configuration and to rotate inward to receive an amount of waste in a deployed configuration, wherein the plurality of weighted rotatable slides 150 are configured to return to the undeployed configuration after the amount of waste is received within the waste bin 400; and moving the top support ring 120 upward by expanding the pleats 132 of the pleated center expandable section 130 by an upward pressure formed by the amount of waste in the waste bin 400 when the amount of waste exceeds a height of the waste bin 400.

In an aspect, the method 500 further comprises: forming the plurality of weighted rotatable slides 150 into a wedge configuration in which a first end 150a has a shape of a circular sector which tapers to a second end 150b; weighting each circular sector of each of the plurality of weighted rotatable slides 150 in a weighted region 154 between the channel and the first end 150a, wherein a weight of the weighted region 154 is equal to a weight of a section 156 of the slide 150 between the channel and the second end 150b.

Numerous modifications and variations of the present disclosure are possible in light of the above teachings. It is therefore to be understood that within the scope of the appended claims, the invention may be practiced otherwise than as specifically described herein.

1. A circular waste bin cover for a waste bin, comprising:
a bottom support ring configured to attach to the waste bin;
a top support ring;
a center expandable section configured to attach to an outer edge of the bottom support ring and to an outer edge of the top support ring, wherein the center expandable section includes pleats which are configured to open to permit the top support ring to move upward when an amount of waste within the waste bin exceeds a height of the waste bin;
a plurality of axle rings connected to the top support ring, where each axle ring is configured to extend at least partially around an inner surface of an opening of the top support ring; and
a plurality of weighted rotatable slides connected to the axle rings, wherein the plurality of weighted rotatable slides are configured to form a closed disposal door in an undeployed configuration and to rotate inward to receive the waste in a deployed configuration, wherein the plurality of weighted rotatable slides are configured to return to the undeployed configuration after the waste is received within the waste bin.

2. The waste bin cover of claim 1, wherein the waste bin has a cylindrical configuration and the bottom support ring, the center expandable section, and the top support ring are circular and sized to fit over a circular opening of the waste bin.

3. The waste bin cover of claim 2, wherein the plurality of weighted rotatable slides each have a wedge configuration in which a first end has a shape of a circular sector which tapers to a second end.

4. The waste bin cover of claim 3, further comprising:
a channel located in the circular sector of each weighted rotatable slide, wherein the channel is configured to receive an end of one of the plurality of axle rings.

5. The waste bin cover of claim 4, wherein the plurality of axle rings consists of a first axle ring and a second axle ring located on opposite sides of the top support ring, wherein each axle ring is configured to hold two weighted rotatable slides.

6. The waste bin cover of claim 4, wherein the plurality of axle rings consists of a first axle ring, a second axle ring and a third axle ring evenly spaced around the top support ring, wherein each axle ring is configured to hold two weighted rotatable slides.

7. The waste bin cover of claim 4, wherein there are N weighted rotatable slides, the top support ring has an inner circumference C and a width of the circular sector of each of the plurality of weighted rotatable slides is about C/N.

8. The waste bin cover of claim 4, wherein the second end of each weighted rotatable slide is shaped as a convex arc and the second ends of the plurality of weighted rotatable slides form a circular opening in the closed disposal door in the undeployed configuration, wherein a diameter of the circular opening is about one sixth of a diameter of the top support ring.

9. The waste bin cover of claim 4, wherein each circular sector of the plurality of weighted rotatable slides includes a weighted region between the channel and the first end, wherein a weight of the weighted region is equal to a weight of a section of the slide between the channel and the second end.

10. The waste bin cover of claim 9, wherein the section of each weighted rotatable slide between the channel and the second end is wedge shaped, wherein the wedge shaped section is tilted at an angle in a range of two degrees to ten degrees with respect to the weighted region between the channel and the first end.

11. The waste bin cover of claim 1, further comprising:
a plurality of telescopic supports configured to connect at a first end to a top surface of the bottom support ring and at a second end to a bottom surface of the top support ring.

12. The waste bin cover of claim 11, wherein each telescopic support includes a first cylinder having a first diameter and a second cylinder having a second diameter which is less than the first diameter, wherein the second cylinder is configured to nest within the first cylinder when an amount of waste is below a level of the bottom support ring and to slide within the first cylinder to permit the top support ring to move upward when an amount of waste within the waste bin exceeds a height of the waste bin.

13. The waste bin cover of claim 12, wherein:
an end of the second cylinder which fits within the first cylinder is configured with an inner ring protrusion, and
an internal surface of a first end of the first cylinder includes a jagged profile configured to prevent the inner ring protrusion of the second cylinder from moving past the first end of the first cylinder.

14. The waste bin cover of claim 1, wherein the center expandable section is made of synthetic leather.

15. The waste bin cover of claim 14, wherein the synthetic leather is made of polyvinyl chloride.

16. The waste bin cover of claim 14, wherein the synthetic leather is made of polyurethane.

17. The waste bin cover of claim 14, further comprising:
a first slot around an outer edge of the top support ring configured for receiving a top edge of the synthetic leather of the center expandable section, wherein the top edge of the synthetic leather is glued to the first slot; and
a second slot around an outer edge of the bottom support ring configured for receiving a bottom edge of the synthetic leather of the center expandable section, wherein the bottom edge of the synthetic leather is glued to the second slot.

18. The waste bin cover of claim 1, further comprising at least one handle connected to the top support ring.

19. A method for assembling an expandable circular waste bin cover for a cylindrical waste bin, comprising:
connecting an outer edge of a bottom support ring to an outer edge of a top support ring by a pleated center expandable section comprising a synthetic leather;
connecting a plurality of telescopic supports at a first end to a top surface of the bottom support ring and at a second end to a bottom surface of the top support ring;
connecting a plurality of axle rings to an inner surface of the top support ring;
connecting a plurality of weighted rotatable slides to the axle rings by inserting an end of each axle ring to a channel in a respective weighted rotatable slide, wherein the plurality of weighted rotatable slides are configured to form a closed disposal door in an undeployed configuration and to rotate inward to receive an amount of waste in a deployed configuration, wherein the plurality of weighted rotatable slides are configured to return to the undeployed configuration after the amount of waste is received within the waste bin; and
moving the top support ring upward by expanding the pleats of the pleated center expandable section by an upward pressure formed by the amount of waste in the waste bin when the amount of waste exceeds a height of the waste bin.

20. The method of claim 19, further comprising:
forming the plurality of weighted rotatable slides into a wedge configuration in which a first end has a shape of a circular sector which tapers to a second end;
weighting each circular sector of each of the plurality of weighted rotatable slides in a weighted region between the channel and the first end, wherein a weight of the weighted region is equal to a weight of a section of the slide between the channel and the second end.
